(19) United States
(12) Patent Application Publication
(10) Pub. No.: US 2012/0070701 A1
(43) Pub. Date: Mar. 22, 2012

(54) METHOD FOR SECURING THE OPERATION OF AN ELECTRIC BATTERY

(75) Inventor: Fabien GABEN, Ecully (FR)

(73) Assignee: DOW KOKAM FRANCE SAS, Massy (FR)

(21) Appl. No.: 13/242,030

(22) Filed: Sep. 23, 2011

Related U.S. Application Data
(63) Continuation of application No. PCT/FR2010/000257, filed on Mar. 25, 2010.

(30) Foreign Application Priority Data
Apr. 2, 2009 (FR) 0901621

(51) Int. Cl. H01M 10/42; H01M 2/30; H01M 2/00

(52) U.S. Cl. 429/7; 429/50

(57) ABSTRACT

The invention relates to a method for securing the operation of an electric battery comprising a plurality of electrical energy-generating elements which are mounted within an electricity production circuit, said method providing for monitoring the occurrence of a malfunction of each of said elements and, in case a malfunction of an element is detected, to actuate a shunting of said defective element so the electrical current no longer crosses through said defective element while maintaining the production circuit closed. The invention also relates to a battery in which such a method can be implemented.

### CROSS-REFERENCE TO RELATED APPLICATIONS

This application is a continuation of International Application No. PCT/FR2010/000257, filed Mar. 25, 2010, which claims the benefit and priority of French Patent Application No. 0901621, filed Apr. 2, 2009. The entire disclosures of the above applications are incorporated herein by reference.

### BACKGROUND

The invention relates to a method for securing the operation of an electric battery as well as a battery in which such a method can be implemented.

An electric battery according to the invention is in particular intended for electrical or hybrid motor vehicle traction, that is to say, comprising an electric motor driving the drive wheels combined with a thermal engine driving these wheels or possibly other drive wheels.

In particular, the invention applies to a high degree of hybridization of thermal vehicles which may go as far as complete electrification of the traction chain. In this case, the batteries do not then merely serve to assist the vehicles in the acceleration phases but also to provide movement of the vehicle autonomously over greater or lesser distances.

The electric battery according to the invention can also find its application in other technical fields, for example the storage of electrical energy in other modes of transportation, particularly in aeronautics. Moreover, in stationary applications such as for windmills, the securing of a battery according to the invention can also be advantageously used.

To guarantee the levels of power and/or energy required for the applications in question, it is necessary to create batteries comprising a plurality of electrical energy-generating elements which are mounted in an electricity production circuit.

The generating elements conventionally comprise a sealed envelope, flexible or rigid, in which a stack or a winding of electroactive layers acting successively as cathodes and anodes is arranged, said layers being put in contact by means of an electrolyte. In particular, electrochemical elements of the lithium-ion or lithium-polymer type can be used to generate the required electrical energy.

However, the generating elements can have malfunctions, for example caused by wear, defective workmanship, or misuse, which can hinder the good functioning of the battery, particularly with respect to safety of use and/or the expected electricity production.

In particular, defective elements can be subjected to a succession of exothermal chemical reactions which can lead to thermal runaway which, combined with gas produced inside the sealed envelope, causes a divergent reaction process putting the element at risk of an explosion.

In order to reduce the risks caused by the malfunctions of the elements, the latter are conventionally provided with various securing devices intended to stop the divergent reaction process. Examples of such devices are presented in the prior art, among which separators, ventings, and cut-offs integrated within the elements.

By way of example, three-layer separators have been developed. They are generally made of layers of polypropylene (PP), polyethylene (PE) in a PP/PE/PP-type configuration. These separators, located between the anode and the cathode of the elements, conduct the current by means of the ion flow of the electrolyte contained in their porosities. At temperatures close to 130° C., these porosities close rapidly and the impedance of the film increases drastically, thus providing it with a function of electrical insulation.

Furthermore, the chemical processes occurring in defective elements give rise to a gas production which, if not rapidly evacuated, leads to the acceleration of the thermal phenomena, thus causing a risk of thermal runaway of the reactions processes that can result in an explosion.

To prevent this risk, venting devices are used to open the envelope of a defective element. The venting devices can be made by locally thinning one of the walls of the battery element, by sharp points integrated onto plates that pierce a diaphragm, or by balls inserted into orifices.

Finally, cut-offs can be integrated into the elements, the circuit opening being able to be triggered when overpressure or overheating occur in the element.

However, the drawback of the securing devices according to the prior art is that they are of the passive type, which means that they are triggered by an action caused by the phenomenon which they aim to secure. Consequently, their triggering, albeit rapid, is carried out only when the phenomenon (temperature, pressure, voltage) is relatively significant, which goes against the intended security.

Furthermore, battery systems according to the prior art integrate other devices serving for their securing, among which:
the contactors which allow for cutting off the passage of the current when the vehicle is stopped, preventing the risks of electrocution by opening the production circuit;
the fuses which protect the battery in case of an external short circuit;
the algorithms for managing the battery which limit the use of the latter in order to prevent the creation of an electrolyte-depleted zone during severe discharges or when metallic salt precipitations occur during the regeneration phase.

Regarding electrical vehicle applications, in case of a malfunction of a battery element, the regulations require that the battery be able to provide energy and power for a duration that is long enough to enable the driver to exit traffic without risk. To meet these requirements, a delay is generally applied between the detection of a malfunction and the opening of the production circuit.

Therefore, when a malfunction occurs in one of the elements, a signal is sent to a main contactor to enable it to open the production circuit. However, in order to leave the driver enough time to exit traffic without danger, a delay of several dozen seconds to one or two minutes is applied before the command for opening the production circuit is effectively carried out (requirements of rule ECE R100). However, during this delay, the operation of the battery is not secure and the defective element still being in production, its malfunction tends to become worse.

Therefore, when a divergent reaction process occurs in an element, the triggering of the associated securing devices (venting, separator, cut-off . . . ) can occur before the main contactor has had time to open.

This configuration poses two risks: the first is relative to an untimely interruption of the energy production, stopping the vehicle amid traffic, which can be rather dangerous; the second consists in triggering an unwanted phenomenon, such as a thermal runaway, the explosion of the battery.

Indeed, for high-power and high-energy batteries which are intended for the traction of motor vehicles, the system operation voltage can reach several hundred volts (generally between 300 and 700V), and the use of devices for securing elements according to the prior are can thus pose problems.

When the elements are mounted in series in the production circuit, the triggering of the securing devices according to the prior art or the appearance of depleted zones in the electrolyte, even a leak of the latter, can create locally a loss of electrical continuity (local formation of a “capacitor”) which can cause electrical arcs to form when the main contactor remains closed. These electrical arcs can start a strong exothermic or even an explosive reaction, on the active materials of the element.

Also, when the elements are mounted in series in the production circuit, the triggering of the securing devices or of the contactors according to the prior art causes the electricity production to be stopped. This untimely interruption in the electricity production, without notice, remains dangerous for the driver of an electric vehicle trapped in the midst of traffic and does not allow for meeting the legal requirements.

According to another embodiment, the battery can comprise a plurality of cells which are mounted in series in the production circuit, each cell comprising at least two elements mounted in parallel. In this embodiment, when the main contactor is closed, the current traversing the defective cell preferably passes through the faultless elements, less resistive, thus creating a risk of overheating, over-discharging, or even inverting one element.

Once the main contactor is open, very high voltages circulate between the faultless elements and the defective elements in the cell, thus worsening the risk of thermal runaway. If all the elements mounted in parallel in a same cell become defective, the same problems as with the configuration in which the elements are mounted in series in the production circuit occur.

Another problem related to the securing of high-energy and high-power batteries arises from the presence of high voltage when medical emergency responders intervene on a vehicle involved in an accident. Indeed, in case of a crash, the mechanical integrity of the battery can be more or less altered. A crushing, even partial, of the battery can cause the contactors to become non-operational and/or create a short-circuit risk.

Moreover, there is a second source of risk for emergency medical responders involved with a vehicle involved in an accident. Indeed, regardless of the state of the contactor, a high voltage remains between the battery elements which are electrically assembled, and the medical responders can be led to come in contact with these sources of voltage.

### SUMMARY

The object of the invention is to solve the problems of the prior art by providing, in particular, a method for securing the operation of a battery that makes it possible to limit, at the earliest, and in a particularly reliable manner the risks connected to a defective element without causing the electricity production to be interrupted. Furthermore, the invention makes it possible to secure a battery for traction of a vehicle involved in an accident, particularly relative to the risks of electrocution for the medical emergency responders.

To this end, according to a first aspect, the invention provides a method for securing the operation of an electric battery comprising a plurality of electrical energy-producing elements which are mounted within an electricity production circuit, said method providing for monitoring the occurrence of a malfunction of each of said elements and, if the malfunction of an element is detected, to actuate a shunting of said defective element so the electric current no longer crosses through said defective element while maintaining the production circuit closed.

According to a second aspect, the invention proposes an electric battery comprising a plurality of electrical-energy producing elements which are mounted in an electricity production circuit, each element being contained in a sealed envelope provided with two terminals for connecting said element to the production circuit, each element being equipped with a selector, movable between a position for connecting the terminals of said element to the production circuit and a shunting position in which the electric current no longer traverses said element while maintaining the production circuit closed, said battery further comprising a device for monitoring the occurrence of a malfunction of each of the elements and a device for actuating the displacement in shunting position of, respectively, a selector in case of detection of a defective operation of the element which it equips.

### DRAWINGS

Other particularities and advantages of the invention will become apparent from the following description given with reference to the accompanying drawings.

FIG. 1 shows the production circuit of an electric battery according to a first embodiment of the invention;

FIG. 2 shows the production circuit of an electric battery according to a second embodiment of the invention;

FIG. 3 shows the assembly of a cell in the production circuit of an electric battery according to an alternative of the second embodiment of the invention;

FIG. 4 shows a selector according to an embodiment of the invention, said selector being shown in the shunting position, from the top (FIG. 4a) and in cross-section AA (FIG. 4b), respectively.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom.

With respect to the figures, an electric battery is described below that comprises a plurality of electrical energy-generating elements E which are mounted in an electricity-producing circuit 1. In particular, the electrochemistry of the elements E can be of the lithium-ion or lithium-polymer type to generate the required energy.

Each element E is contained in a sealed envelope which is provided with two terminals, an anode and a cathode, respectively, for connecting said element to the production circuit 1. In the envelope, a stack or a winding of electroactive layers acting successively as an anode and a cathode is arranged, said layers being put in contact by means of an electrolyte. The layers can be contained within a flexible envelope. Alternatively, they can be contained in a rigid container.

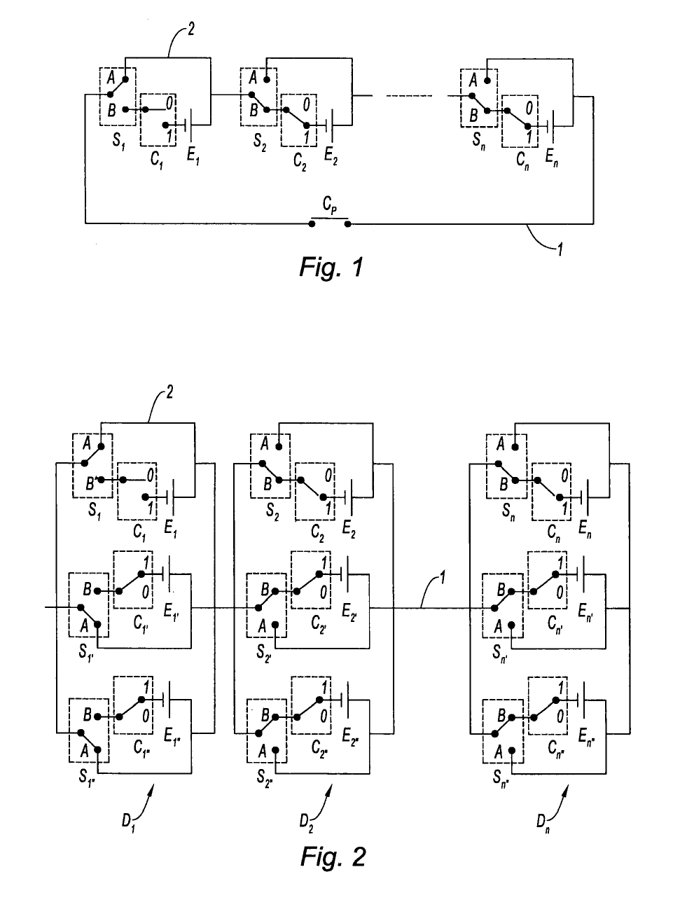

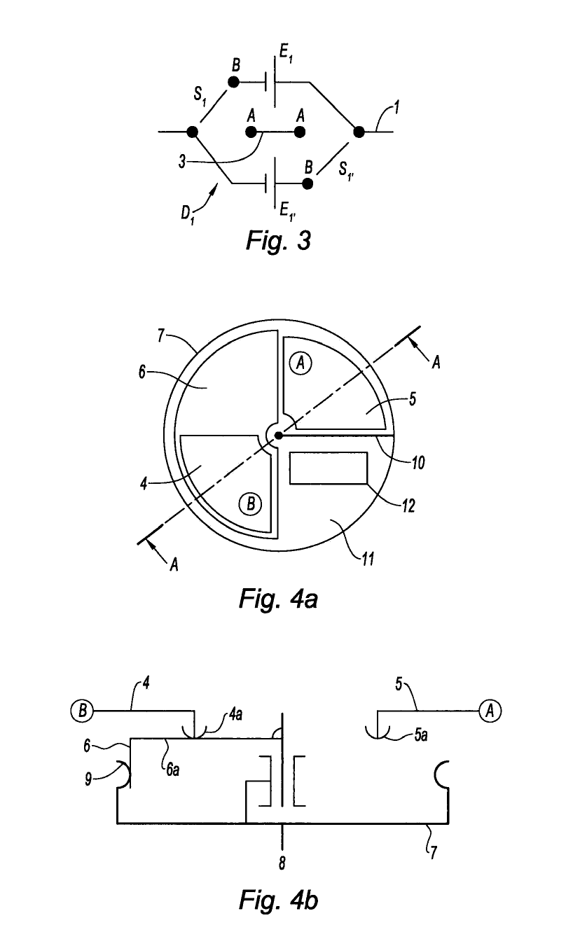

According to a first embodiment shown in FIG. 1, the elements E₁-Eₙ are mounted in series in the production circuit 1. In a second embodiment, the battery comprises a plurality of cells D₁-Dₙ which are mounted in series in the production circuit 1, each cell D comprising at least two elements E mounted in parallel. In FIG. 2, each cell D₁-Dₙ comprises three elements E₁, E_{1′}, E_{1″}-Eₙ, E_{n′}, E_{n″}in parallel and FIG. 3 represents a cell D₁ with two elements E₁, ^{E1′}mounted in parallel.

Each element E is provided with a selector S which is movable between a position B for connecting the terminals of the element E to the production circuit 1 and a shunting position A in which the electric current no longer crosses through said element while keeping the production circuit 1 closed so the other elements E connected to the production circuit 1 can continue providing the required electricity.

Therefore, the securing of the battery operation can be carried out by monitoring the occurrence of a malfunction of each of the elements E and, in case the malfunction of an element E is detected, by actuating the shunting of said defective element so the electric current no longer travels through said defective element while keeping the production circuit 1 closed.

To do so, the battery comprises a device for monitoring the occurrence of a malfunction of each of the elements E and a device for actuating the displacement in the shunting position A, respectively, of a selector S in case of detection of a malfunction of the element E which it equips.

The detection of a malfunction makes it possible to rapidly actuate the shunting of the defective element E in order to electrically isolate said defective element from the production circuit 1. Therefore, as soon as a malfunction occurs, the defective element E is no longer electrically biased so as, in particular, to prevent a worsening of said malfunction which could lead to a risky event relative to the battery operation. In particular, any thermal runaway within a defective element E is thus avoided. Moreover, the electrical production of the battery is thus not interrupted, which means, in particular, that the requirements relative to the time necessary for the driver to exit traffic without danger can be met.

According to an advantageous embodiment, monitoring the occurrence of a malfunction of an element E involves measuring the voltage at the terminals of said element, said measuring being conventionally carried out by the monitoring electronic system of the battery. In the embodiment where the production circuit 1 comprises cells D, the voltage measurement can be carried out at the terminals of said cells. Then, the measured voltage is compared with a threshold value, the defective operation being detected when said measured voltage is less than said threshold value. For example, the threshold value can be comprised between 0.2 and 2 V, for example on the order of 1 V.

In the embodiments shown, a terminal of the element E is connected to the production circuit 1 by means of a selector S. Moreover, as shown in FIG. 1, the production circuits 1 can integrate a main contactor Cₚ which, after shunting of a defective element E, can be actuated to open the production circuit 1, particularly in a delayed manner, so the driver can exit traffic without danger.

Also, the elements E can also be provided with separators, ventings and/or cut-offs such as those known in the prior art. These devices can, after shunting, be activated without the risk of electrical breakdown since the element E is then electrically isolated.

In addition, the securing method can be provided for the detection of a shock which could affect the battery. In particular, in the case of a battery adapted to the traction of a motor vehicle, the detected shock can concern an accident of said vehicle, in particular a crash which could affect the mechanical integrity of the battery. In an example of embodiment, the shock can be detected by the system which is integrated in the vehicle for that purpose, particularly in order to trigger active safety devices such as airbags.

Therefore, the method provides for using the information which is available in the vehicle to activate the shunting of all the elements E of said battery in case of such a shock, so as to eliminate any risk of electrocution of medical emergency responders by contact with the high voltage of the battery. Also, the selectors S can be provided to be disassembled from elements E to make it easy to replace them after an accident in which said elements were not damaged.

The production circuits 1 shown integrate a mapping of the occurrence of a defect on an element E in the form of a contactor C without, however, said circuits integrating such contactors, the position 1 corresponding to the lack of defect and the position 0 to the detection of a defect on the element E. Therefore, in FIGS. 1 and 2, the element E presents a malfunction and the selector S₁ is thus in position shunting A.

In relation with the FIGS. 1 and 2, a shunting loop 2 which equips each of the elements E is shown, said loop being connected on both sides of the terminals of said element. Thus, the selector S in the connection position B connects the terminals of the element E to the production circuit 1 and, in the shunting position A, connects said loop to said circuit.

According to an embodiment, the shunting loop 2 can comprise a resistance. In particular, in the case of a battery integrating cells D (FIG. 2), such resistance makes it possible to prevent the current from looping back in the elements E of the cell D comprising a shunted element E.

According to another embodiment, the same effect can be achieved by providing, in case of malfunction of an element E of a cell D, for the shunting of all the elements E of said cell to be actuated, so as to prevent the risks of over-discharging elements E or of inversion in one of the elements E of the cell D.

In FIG. 3, the two elements E₁, E_{1′}, of cell D₁ are provided with a shunting branch 3 having two terminals, each selector S connecting to the production circuit 1 the terminals of an element E or one of the terminals of the shunting branch 3.

Therefore, when the two selectors S₁, S_{1′}, are in the connection position (FIG. 3), the two elements E₁, E_{1′}, are mounted in parallel and, as soon as a defect is detected, the corresponding selector S passes in the shunting position A on a terminal of the branch 3 without risking the current looping back to the other element E.

With regard to FIGS. 4a and 4b, an embodiment of a selector S which can be activated by displacement between the positions of connection B and of shunting A is described below. In particular, the selector A can be screwed onto the connector structure E so that a disassembly function can be integrated. Similarly, the means for measuring the voltage at the terminals of an element E can be integrated into a module comprising the selector S, said module being detachably mounted on the connector structure of said element.

The selector S shown comprises three members connected to the production circuit 1, two members 4, 5 being stationary and a member 6 being rotatable between two positions A, B for connecting with, respectively, one of the stationary members 4, 5. In particular, the selector S comprises a stationary box 7 which is connected 8 to the production circuit 1, the rotatable ember 6 being connected 9 in rotation to said box. The stationary members 4, 5 are mounted in the box 7 while being respectively connected to a terminal of the element E and to the loop 2 or to the shunting branch 3.

In the embodiment shown, the displacement between the connection position B and the shunting position A can be made in a progressive manner in order to ensure a gradual diminution of the electric current passing through the defective element E. Therefore, the formation of an electrical arc during the actuation of the selector S is prevented.

To do so, the members 4-6 have respective contact surfaces 4a-6a which are arranged so that the rotatable member 6 ensures a progressive transition of the connection from a stationary member 4 toward the other stationary member 5 in order to achieve an electrical continuity in said transition.

In the figures, the rotation of the member 6 is limited to 90° by an abutment wall 10 and its contact surface 6a extends in a semicircle. Furthermore, the contact surface 4a, 5a of the stationary members 4, 5, extends in a quarter circle, said surfaces being positioned symmetrically at 180° from one another. Therefore, during the rotation of the member 6, the sum of the contact surface between the rotatable member 6 and the stationary members 4, 5 remains substantially constant, while ensuring the passage of the current from a stationary member 4 toward the other 5.

Advantageously, the device can comprise a means for applying a mechanical displacement force of the selector S between its positions of connection B and shunting A so as to be able to overcome the contact forces which are necessary to these connections. Indeed, to ensure a good quality of connection, capable of allowing the required energy to pass, even in severe vibratory conditions, the contacts between the members 4-6 can be advantageously carried out by a tight assembly of the press-fit type.

In particular, the means can be chosen among pyrotechnic means, piezoelectric means, particularly a piezoelectric motor, mechanical means, particularly a pre-stressed spring, and electro-mechanical means, particularly an electromagnet freeing a pre-stressed mechanical member.

In the embodiment shown, the box 7 integrates a compartment 11 delimited on both sides by the wall 10 and by the rotatable member 6, in which a pyrotechnic means 12 are arranged. The pyrotechnic means 12 comprise a charge and an igniter which is activated during the detection of some malfunction, by generating gas in the compartment 11, to push the member 6 in rapid rotation between its two connection positions A, B. The time necessary between the detection of a malfunction, particularly by measuring the voltage of the elements E, and the shunting of an element E can be less than 1 second, for example on the order of several dozen or even a hundred milliseconds.

1-17. (canceled)

18. A method for securing the operation of an electric battery comprising a plurality of electrical energy-generating elements which are mounted within an electricity production circuit, said method providing for monitoring the occurrence of a malfunction of each of said elements and, in case the malfunction of an element is detected, to actuate a shunting of said defective element so the electrical current no longer crosses through said defective element while maintaining the production circuit closed, wherein the shunting of said defective element is carried out by means of a selector which can be actuated in displacement between a connection position of said defective element to the production circuit and a position for shunting said defective element and disconnecting said defective element from the production circuit.

19. The securing method according to claim 18, wherein the monitoring of the occurrence of a malfunction of an element comprises measuring the electric voltage at the terminals of said element and the comparing of said measured voltage with a threshold value, the defective operation being detected when said measured voltage is less than said threshold value.

20. The securing method according to claim 18, wherein it further provides, after the shunting of a defective element, for a delayed opening of the production circuit.

21. The securing method according to claim 18, wherein the displacement between the connection position and the shunting position can be made in a progressive manner in order to ensure a gradual diminution of the passage of the electric current in the defective element.

22. The securing method according to claim 18, wherein the battery comprises a plurality of cells which are mounted in series in the production circuit, each cell comprising at least two elements mounted in parallel, said method providing, in case of a malfunction of an element of a cell, for actuating the shunting of all the elements of said cell.

23. The securing method according to claim 18, wherein it provides for the detection of a shock that can affect the battery and, in case such a shock occurs, for the shunting of all the elements of said battery.

24. An electric battery comprising:
(a) a plurality of electrical energy-generating elements which are mounted in an electricity production circuit, each element being contained in a sealed envelope provided with two terminals for connecting said element to the production circuit, and each element being equipped with a selector, movable between a position for connecting the terminals of said element to the production circuit and a shunting position in which the electric current no longer traverses said element while maintaining the production circuit closed and in which said element is disconnected from the production circuit; and
(b) a device for monitoring the occurrence of a malfunction of each of the elements and a device for actuating the displacement in the shunting position of, respectively, a selector in case of detection of defective operation of the element which it equips.

25. The electric battery according to claim 24, wherein a terminal of the element is connected to the production circuit by means of the selector.

26. The electric battery according to claim 24, wherein the elements are mounted in series in the production circuit.

27. The electric battery according to claim 24, wherein it comprises a plurality of cells which are mounted in series in the production circuit, each cell comprising at least two elements mounted in parallel.

28. The electric battery according to claim 27, wherein each cell comprises two elements in parallel and a shunting branch having two terminals, each selector connecting to the production circuit the terminals of an element or one of the terminals of the shunting branch.

29. The electric battery according to claim 24, wherein each element is equipped with a shunting loop which is mounted on both sides of the terminals of said element, the selector connecting to the production circuit said terminals or the shunting loop.

30. The electric battery according to claim 29, wherein the shunting loop comprises a resistance.

31. The electric battery according to claim 24, wherein the selector comprises three members connected to the production circuit, two members being stationary and a member being rotatable between two positions for connecting with, respectively, one of the stationary members.

32. The electric battery according to claim 31, wherein the members have respective contact surfaces which are arranged so that the rotatable member ensures a progressive transition of the connection between a stationary member toward the other stationary member.

33. The electric battery according to claim 24, wherein the actuation device comprises a means for applying a mechanical displacement force of the selector between its positions of connection and shunting, said means being chosen among the pyrotechnic means, the piezoelectric means, the mechanical means, the electro-mechanical means.
